(19) United States
(12) Patent Application Publication
(10) Pub. No.: US 2003/0008564 A1
(43) Pub. Date: Jan. 9, 2003

(54) Plug adapter

(76) Inventor: Gregory L. Lebron, Verona, NJ (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 09/894,364

(22) Filed: Jun. 28, 2001

(51) Int. Cl. H01R 25/00

(52) U.S. Cl. 439/638

(57) ABSTRACT

A plug adapter that allows any headset to be used with any handheld two-way radio is disclosed. The adapter has a body having first and second distal ends. The first distal end is a jack, adapted to receive a headset plug. The jack has a ring electrical contact to mate with a conductive ring of the headset plug and a conductive tip contact to mate with the conductive tip of the headset's plug. The electrical contacts in the jack are electrically isolated from each other. The second distal end of the adapter forms a plug having at least a conductive ring and a conductive tip. The conductive ring and conductive tip are electrically isolated from each other. The adapter electrically connects the jack's ring electrical contact to the conductive tip of the adapter's plug and the jack's conductive tip contact to the conductive ring of the adapter's plug.

### FIELD OF THE INVENTION

The invention relates to electrical adapters, and more particularly to polarity reversing plug adapters.

### BACKGROUND OF THE INVENTION

Many electronic components are manufactured with input and output jacks. In particular, handheld two-way radios are designed with one or two jacks so that they can be used with headsets. The two-way radios that have two separate jacks use one jack for a microphone input and the other jack for a speaker output. The headsets typically contain both a microphone and speaker. Each manufacturer chooses the size of jack and plug combination to use. Additionally, each manufacturer assigns a specific polarity to the plug and jack combination selected for each two-way radio. Due to this nonuniformity, headset manufacturers are forced to produce two-way radio specific headsets. Further, consumers are limited in the styles of headsets they can use due to incompatibility between various manufacturers.

There are many two-way radios, cellular telephones, and other products on the market, which have jacks for audio inputs and outputs. These jacks typically accept either a 2.5-millimeter plug or a 3.5-millimeter plug. For units that require only a single jack, the associated plug has three electrical contacts, a tip contact, a ring contact, and third ground contact. There are adapters known in the art that are used to merely modify a 2.5 mm plug to a 3.5 mm plug or a 3.5 mm plug to a 2.5 mm plug. While the ground contact is standard throughout the industry, many manufacturers switch the assignment of the ring and tip contacts of the plug. When the tip contact is assigned to the microphone, the ring contact is assigned to the speaker, and vice versa. There are three headset to two-way radio jacks commonly in use. The three connections are: a 2.5 millimeter jack for both the microphone and speaker; a 3.5 millimeter jack for both the microphone and speaker; and a 2.5 millimeter jack and 3.5 millimeter jack for the microphone and the speaker, respectively. Additionally, some two-way radios have other features used in voice transmission, such as voice activated transmission or push-to-talk transmission whereby a microphone switch is depressed for transmission.

Thus, there is a need for adapters to allow headsets of one type to be used with any handheld two-way radios of another type.

### BRIEF SUMMARY OF THE INVENTION

A plug adapter that allows a headset having a first plug polarity to be used with a handheld two-way radio having a different polarity is disclosed. The adapter has a body having first and second distal ends. The first distal end includes a jack, adapted to receive a headset plug. The jack has a ring electrical contact to mate with a conductive ring of the headset plug and a conductive tip contact to mate with the conductive tip of the headset's plug. The electrical contacts in the jack are electrically isolated from each other. The second distal end of the adapter forms a plug having at least a conductive ring and a conductive tip. The conductive ring and conductive tip are electrically isolated from each other. The adapter electrically connects the jack's ring electrical contact to the conductive tip of the adapter's plug and the jack's conductive tip contact to the conductive ring of the adapter's plug.

### BRIEF DESCRIPTION OF THE DRAWINGS

FIG. 1 is a view of one embodiment of an adapter having one jack and one plug in accordance with the invention;

FIG. 2 is a view of one embodiment of an adapter showing the electrical contacts in the jack in accordance with the invention;

FIG. 3 is a schematic view of one embodiment of the jack end of the adapter;

FIG. 4 is a view of another embodiment of an adapter having one jack and two plugs showing the electrical contacts in the jack and plugs in accordance with the invention;

FIG. 5 is a view of one embodiment of an adapter, showing the electrical contacts in the jack, having a push-to-talk switch in accordance with the invention;

FIG. 6 is a view of another embodiment of an adapter, showing the electrical contacts, having two jacks; and

FIG. 7 is a view of another embodiment of an adapter, showing the electrical contacts, having two plugs.

### DETAILED DESCRIPTION OF THE INVENTION

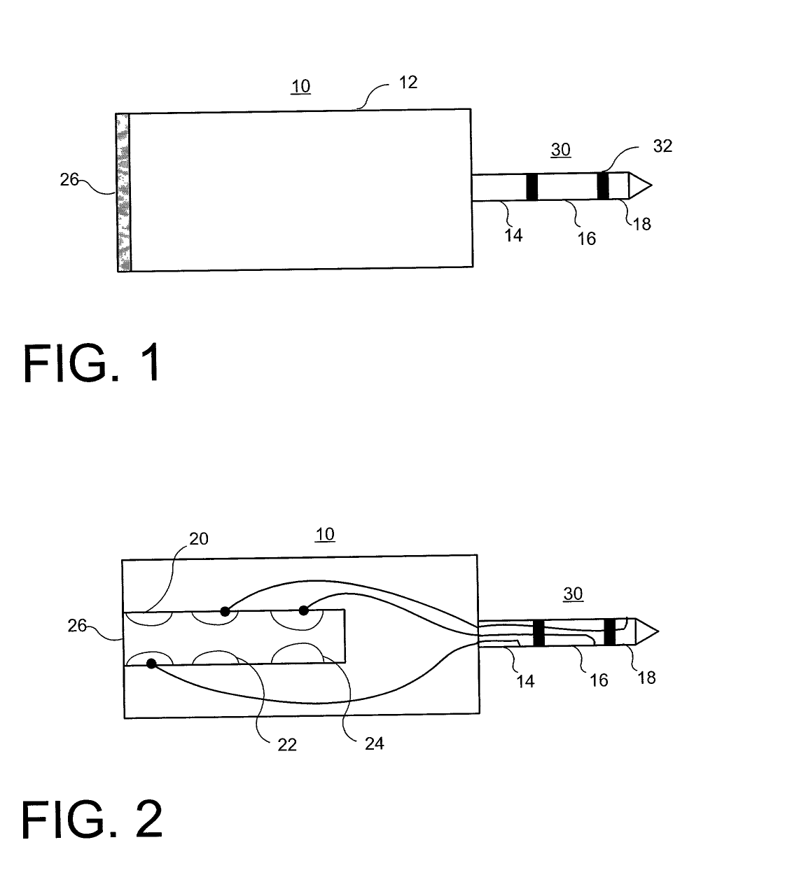

FIG. 1 shows one embodiment of an adapter 10 in accordance with the invention. The body 12 of the adapter 10 has two ends. A first end of the body 12 has a jack 26. A second end of the body 12 has a plug 30. In one embodiment to the invention, plug 30 has at least two conductive sections, conductive tip 18 and conductive ring 16. The conductive tip and the conductive ring are electrically isolated from one another by an insulator such as insulator 32. In one embodiment to the invention, plug 30 has a third section 14. In use, the three electrical connections of the plug are assigned to a microphone, a speaker, and ground. The body 12 of adapter 10 can be round, square, or any other shape that is easy to mold and handle. In one embodiment of the invention, both ends of body 12 have jacks. In another embodiment of the invention, both ends of body 12 have plugs.

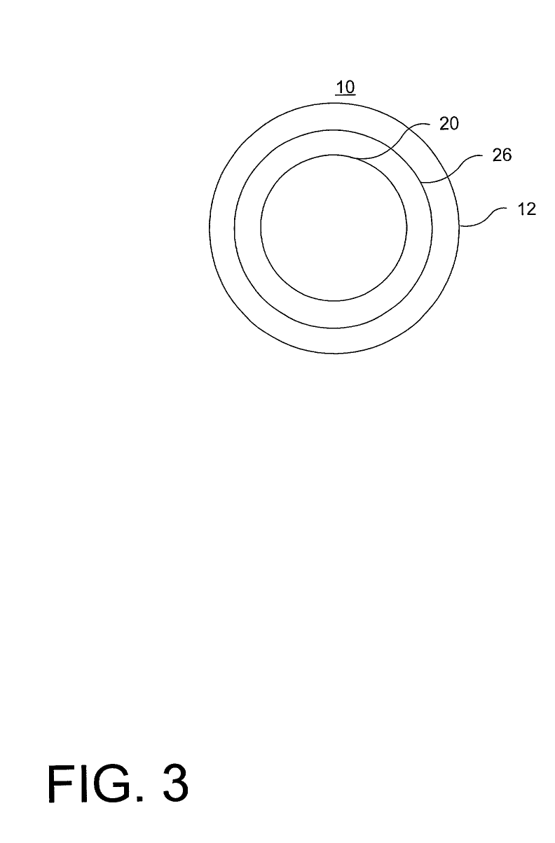

As shown in FIG. 2, jack 26 has at least two electrical contacts, a tip contact 24, and a ring contact 22. In one embodiment of the invention, as shown in FIG. 3, contact 20 follows the entire circumference of the jack. In another embodiment of the invention, the contacts in the jack as segmented, i.e., not around the entire circumference of the jack. The diameter of the jack is designed to accept an industry standard plug such as a 2.5 millimeter plug or a 3.5 millimeter plug. Likewise, plug 30 is designed to be an industry standard plug such as a 2.5 millimeter plug, a 3.5 millimeter plug, or the like.

There are a number of possible combinations of jack and plug diameter. Additionally, there are a number of different combinations of electrical connections between the jack electric contacts and plug electric contacts. Available plug and jack sizes are shown is Table 1. Additionally, in double-jack embodiments or double-plug embodiments the same size combinations apply.

| Plug | Jack |
|---|---|
| 2.5 millimeter | 2.5 millimeter |
| 3.5 millimeter | 2.5 millimeter |
| 2.5 millimeter | 3.5 millimeter |
| 3.5 millimeter | 3.5 millimeter |

In one embodiment of the invention, adapter 10 is used when a headset having a 3.5-millimeter plug is to be mated with a radio having a 2.5-millimeter jack. If the plug polarity is the same for both the headset plug and radio jack, jack contact 24 is electrically connected to conductive tip 18; ring contact 22 is connected to plug ring contact 16; and contact 20 is connected to plug contact 14. Likewise, if the plug and tip of the headset have a different polarity, the electrical connections to the plug contact will be different.

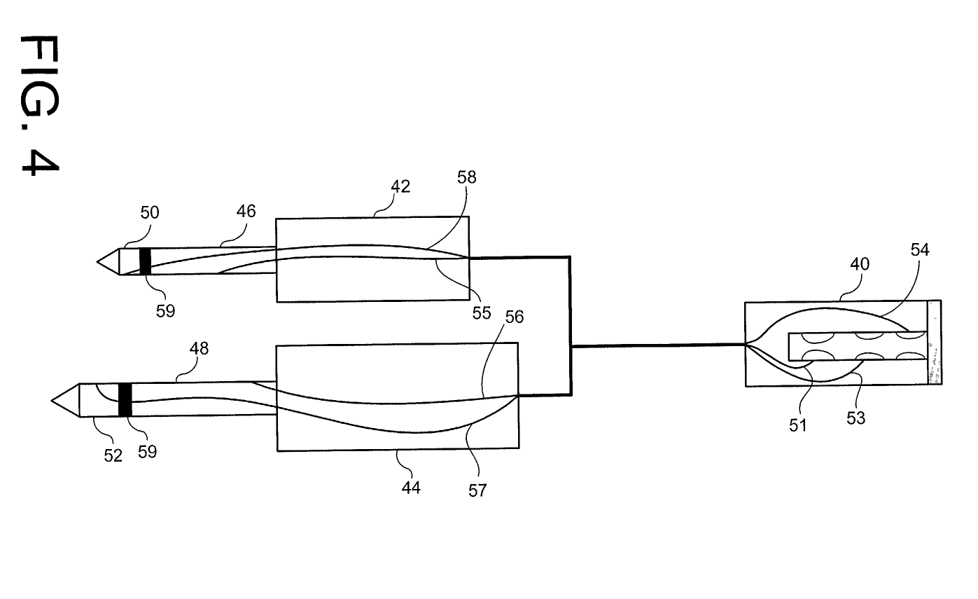

As shown in FIG. 4, a single jack 40 having internal contacts for a tip contact, a ring contact, and a ground contact may divide the connections to separate plugs. An adapter in accordance with one aspect of the invention, as shown in FIG. 4, is used when a headset has a single plug yet the radio it is to be mated with has a separate speakerjack and microphone jack. As shown, plug 42 is a 2.5-millimeter plug and plug 44 is a 3.5-millimeter plug. In one embodiment of the invention, plug ring portion 46 and plug ring portion 48 are ground connected to the ground contact of jack 40. Additionally, tips 50 and 52 are connected to either a tip contact in jack 40 or a ring contact in jack 40.

In one embodiment of the invention, conductor 54 is contiguous with conductors 55 and 56. Alternatively, conductor 54 can be contiguous with conductors 57 or 58, as required. Further, conductors 51 and 53 couple to a headset's plug contacts through contacts in jack 40. As required, for various adapters, the headset plug contacts are routed to adapter plug contacts 50, 46, 52, and 48 such that the headset plug contacts are coupled to the appropriate two-way radio plug contacts. The plug contacts 50, 46, 52, and 48 are separated by insulator portions 59.

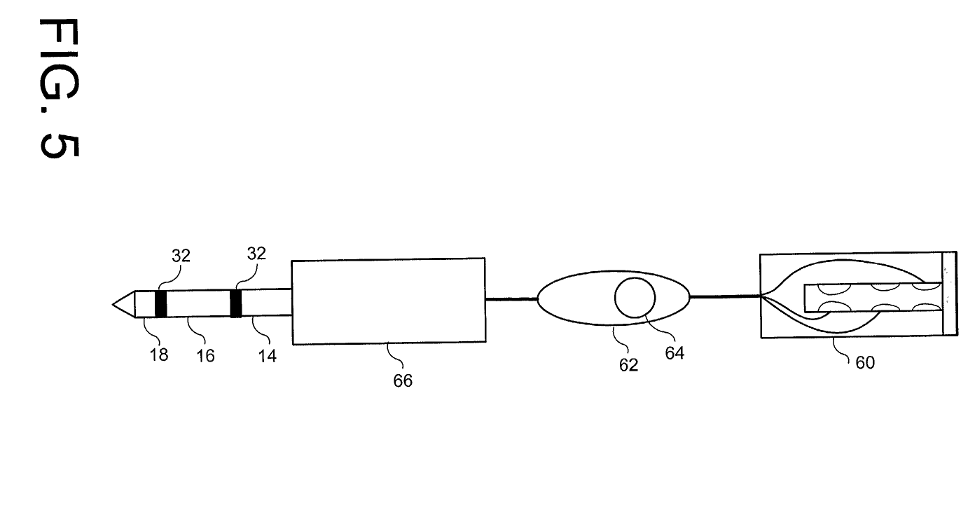

As shown in FIG. 5, an adapter may include a push-to-talk assembly 62. The push-to-talk assembly 62 includes a push-to-talk button 64. Jack 60 has three sets of contacts, a tip contact, a ring contact, and a ground contact. Likewise, plug 66 has three contacts, a conductive tip 18, a conductive ring 16, and a ground conductor 14. The plug contacts are insulated from one another and separated by insulators 32. Any one of the plug contacts can be assigned to the microphone. The electrical connection between the electrical contact of the plug that serves as the microphone contact and the electrical contact of the jack that serves as a microphone contact enters the push-to-talk housing 62. The microphone connection passes through the push-to-talk button 64. In one embodiment to the invention, push-to-talk button 64 controls a momentary on button. In another embodiment of the invention, push-to-talk button 64 controls an on/off switch. Several varieties of push-to-talk adapters can be manufactured to account for the different jack assignments in two-way radios. A unique adapter for each size and wiring combination can be manufactured. Alternatively, the push-to-talk plug contacts have the same size and electrical connections as the headset's plug and a separate size and or polarity reversing adapter is used in series with the push-to-talk to mate with the input jack of a two-way radio.

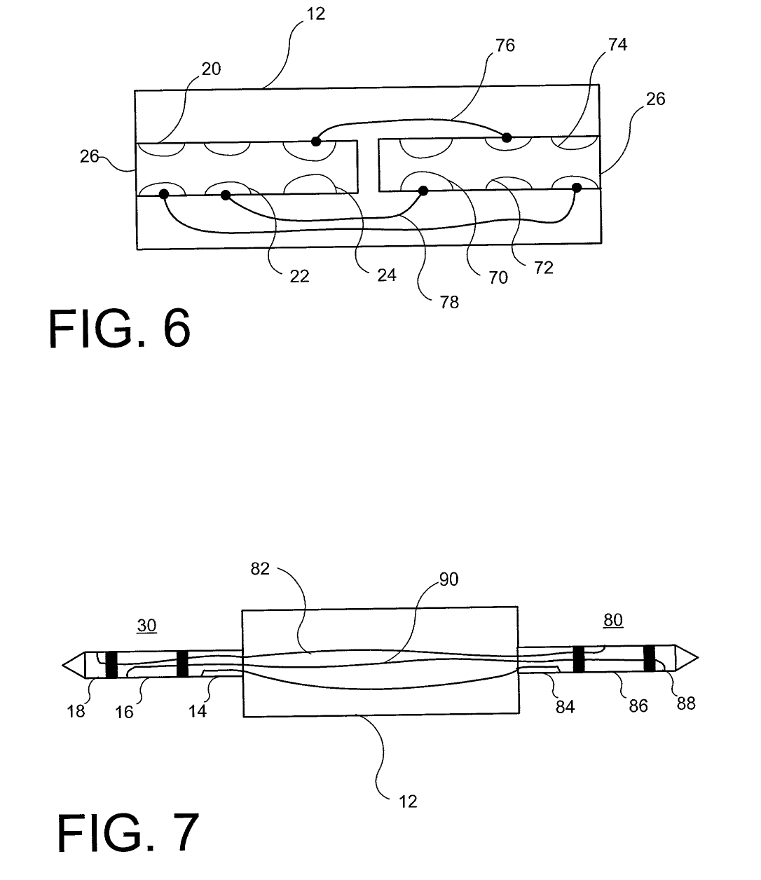

As shown in FIG. 6, the body 12 of the adapter has two ends. Both ends of the body 12 have jacks 26. The body 12 of adapter 10 can be round, square, or any other shape that is easy to mold and handle. Jacks 26 have at least two electrical contacts, a first tip contact 24, a first ring contact 22, a second tip contact 70, and a second ring contact 72. In one embodiment of the invention, as shown in FIG. 3, contact 20 follows the entire circumference of the jack. In another embodiment of the invention, the contacts in the jack as segmented, i.e., not around the entire circumference of the jack. The diameter of the jack is designed to accept an industry standard plug such as a 2.5 millimeter plug or a 3.5 millimeter plug. In one embodiment, jacks 26 each have a third contact 20 and 74. As shown, the third contacts are electrically connected to each other. Further, first tip contact 24 is electrically connected 76 to second ring contact 72 and first ring contact 22 is electrically connected 78 to second tip contact 70. In one embodiment of the invention, a momentary push-to-talk switch is inserted in electrical connection 76 or 78.

As shown in FIG. 7, the body 12 of the adapter has two ends. The ends of the body 12 have plugs 30 and 80. The body 12 of adapter can be round, square, or any other shape that is easy to mold and handle. Plugs 30 and 80 have at least two electrical contacts, a first tip 18, a first ring 16, a second tip 88, and a second ring 86. The diameter of the plugs is designed to mate with an industry standard jack such as a 2.5 millimeter jack or a 3.5 millimeter jack. In one embodiment, plugs 30 and 80 each have a third contact 14 and 84. As shown, the third contacts are electrically connected to each other. Further, first tip 18 is electrically connected 76 to second ring 86 and first ring 16 is electrically connected 78 to second tip 88. In one embodiment of the invention, a momentary push-to-talk switch is inserted in electrical connection 82 or 90.

The adapter is simple to use. First, the proper adapter must be selected. The selection process begins by first determining if the desired headset plug is the same size as the radio jack. If a size conversion is required a size converting adapter is selected, otherwise an adapter with the same size jack and plug as the headset is selected. An adapter with the same size plug and jack is selected in situations where the headset plug is connected differently than the two-way radio jack. Additionally, if a single plug headset is to be used with a radio having separate microphone and speaker jacks, a single jack, two plug adapter is selected. Next, the adapter with the proper electrical connections must be selected. This selection is done such that the adapter plug and tip contacts will mate with the proper radio contacts, i.e., microphone contact to microphone contact and speaker contact to speaker contact. Additionally, multiple adapters can be used in series if required. In this manner, a push to talk adapter may be added as well as a polarity reversing adapter.

Although the present invention was discussed in terms of certain preferred embodiments, the invention is not limited to such embodiments. Rather, the invention includes other embodiments including those apparent to a person of ordinary skill in the art. Thus, the scope of the invention should not be limited by the preceding description but should be ascertained by reference to the claims that follow.

What is claimed is:

1. A plug adapter comprising:
(a) a body having first and second distal ends, said first distal end being a jack adapted to receive a first plug of a first diameter having at least a first conductive ring and a first conductive tip, said second distal end forming a second plug of a second diameter having at least a second conductive ring and a second conductive tip;
(b) said jack having at least a first and second electrical contact, said first electrical contact being insulated from said second electrical contact, said first electrical contact adapted to mate with said first conductive ring of said first plug and said second electrical contact adapted to mate with said first conductive tip of said first plug;
(c) said second plug having second conductive ring electrically insulated from said second conductive tip; and
(d) said first electrical contact being electrically connected to said second conductive tip and said second electrical contact is electrically connected to said second conductive ring.

2. The plug adapter according to claim 1 wherein said jack is adapted to accept a first plug having a first diameter of approximately 2.5 mm.

3. The plug adapter according to claim 2 wherein said second plug has a second diameter of approximately 2.5 mm.

4. The plug adapter according to claim 2 wherein said second plug has a second diameter of approximately 3.5 mm.

5. The plug adapter according to claim 3 wherein said jack has a third electrical contact, said third electrical contact being electrically insulated from said first and second electrical contacts and said second plug has a third conductive ring, said third conductive ring being electrically insulated from second conductive ring and said second conductive tip, wherein said third electrical contact is electrically connected to said third conductive ring.

6. The plug adapter according to claim 4 wherein said jack has a third electrical contact, said third electrical contact being electrically insulated from said first and second electrical contacts and said second plug has a third conductive ring, said third conductive ring being electrically insulated from said second conductive ring and said second conductive tip, wherein said third electrical contact is electrically connected to said third conductive ring.

7. The plug adapter according top claim 5 wherein a momentary closed switch is electrically disposed between said first electrical contact and said second conductive tip.

8. The plug adapter according to claim 5 wherein a momentary closed switch is electrically disposed between said second electrical contact and said second conductive ring.

9. The plug adapter according to claim 6 wherein a momentary closed switch is electrically disposed between said second electrical contact and said second conductive ring.

10. The plug adapter according top claim 6 wherein a momentary closed switch is electrically disposed between said first electrical contact and said second conductive tip.

11. A plug adapter comprising:
(a) a body having first and second distal ends, said first distal end being a first jack adapted to receive a first plug of a first diameter having at least a first conductive ring and a first conductive tip, said second distal end being a jack adapted to receive a second plug of a second diameter having at least a second conductive ring and a second conductive tip;
(b) said first jack having at least a first and second electrical contact, said first electrical contact being insulated from said second electrical contact, said first electrical contact adapted to mate with said first conductive ring of said first plug and said second electrical contact adapted to mate with said first conductive tip of said first plug;
(c) said second jack having at least a third and forth electrical contact, said third electrical contact being insulated from said forth electrical contact, said third electrical contact adapted to mate with said second conductive ring of said second plug and said forth electrical contact adapted to mate with said second conductive tip of said second plug; and
(d) said first electrical contact being electrically connected to said forth electrical contact and said second electrical contact is electrically connected to said third electrical contact.

12. The plug adapter according to claim 11 wherein said first jack is adapted to accept a first plug having a first diameter of approximately 2.5 mm and said second jack is adapted to accept a second plug having a second diameter of approximately 2.5 mm.

13. The plug adapter according to claim 11 wherein said second jack is adapted to accept a second plug having a first diameter of approximately 2.5 mm and said second jack is adapted to accept a second plug having a first diameter of approximately 3.5 mm.

14. The plug adapter according to claim 11 wherein said first jack is adapted to accept a first plug having a first diameter of approximately 3.5 mm and second jack is adapted to accept a second plug having a second diameter of approximately 3.5 mm.

15. The plug adapter according to claim 12 wherein said first jack has a fifth electrical contact, said fifth electrical contact being electrically insulated from said first and second electrical contacts and said second jack has a sixth electrical contact, said sixth electrical contact being electrically insulated from third electrical contact and said forth electrical contact, wherein said fifth electrical contact is electrically connected to said sixth electrical contact.

16. The plug adapter according to claim 13 wherein said first jack has a fifth electrical contact, said fifth electrical contact being electrically insulated from said first and second electrical contacts and said second jack has a sixth electrical contact, said sixth electrical contact being electrically insulated from third electrical contact and said forth electrical contact, wherein said fifth electrical contact is electrically connected to said sixth electrical contact.

17. The plug adapter according top claim 15 wherein a momentary closed switch is electrically disposed between said first electrical contact and said forth electrical contact.

18. The plug adapter according to claim 15 wherein a momentary closed switch is electrically disposed between said second electrical contact and said third electrical contact.

19. The plug adapter according to claim 16 wherein a momentary closed switch is electrically disposed between said second electrical contact and said third electrical contact.

20. The plug adapter according top claim 16 wherein a momentary closed switch is electrically disposed between said first electrical contact and said forth electrical contact.

21. A plug adapter comprising:
(a) a body having first and second distal ends, said first distal end being a first plug of a first diameter having at least a first conductive ring and a first conductive tip, said second distal end being a second plug of a second diameter having at least a second conductive ring and a second conductive tip;
(b) said first plug having said first conductive ring electrically insulated from said first conductive tip;
(c) said second plug having second conductive ring electrically insulated from said second conductive tip; and
(d) said first electrical conductive ring being electrically connected to said second conductive tip and said first conductive tip is electrically connected to said second conductive ring.

22. The plug adapter according to claim 21 wherein said first plug has a first diameter of approximately 2.5 mm and said second plug has a second diameter of approximately 2.5 mm.

23. The plug adapter according to claim 21 wherein said first plug has a first diameter of approximately 3.5 mm and said second plug has a second diameter of approximately 3.5 mm.

24. The plug adapter according to claim 21 wherein said first plug has a first diameter of approximately 2.5 mm and second plug has a second diameter of approximately 3.5 mm.

25. The plug adapter according to claim 22 wherein said first plug has a third conductive ring, said third conductive ring being electrically insulated from said first conductive ring and a first conductive tip and said second plug has a forth conductive ring, said forth conductive ring being electrically insulated from second conductive ring and said second conductive tip, wherein said third conductive ring is electrically connected to said forth conductive ring.

26. The plug adapter according to claim 22 wherein said first plug has a third conductive ring, said third conductive ring being electrically insulated from said first conductive ring and a first conductive tip and said second plug has a forth conductive ring, said forth conductive ring being electrically insulated from second conductive ring and said second conductive tip, wherein said third conductive ring is electrically connected to said forth conductive ring.

27. The plug adapter according top claim 25 wherein a momentary closed switch is electrically disposed between said first conductive ring and said second conductive tip.

28. The plug adapter according to claim 25 wherein a momentary closed switch is electrically disposed between said first conductive tip and said second conductive ring.

29. The plug adapter according to claim 26 wherein a momentary closed switch is electrically disposed between said first conductive tip and said second conductive ring.

30. The plug adapter according top claim 26 wherein a momentary closed switch is electrically disposed between said first conductive ring and said second conductive tip.
